(19) United States
(12) Patent Application Publication
(10) Pub. No.: US 2026/0030127 A1
(43) Pub. Date: Jan. 29, 2026

(54) FIRMWARE MANAGEMENT FOR MEMORY SYSTEMS

(71) Applicant: Micron Technology, Inc., Boise, ID (US)

(72) Inventor: Marco Redaelli, München (DE)

(21) Appl. No.: 19/271,626

(22) Filed: Jul. 16, 2025

Related U.S. Application Data
(60) Provisional application No. 63/676,224, filed on Jul. 26, 2024.

(51) Int. Cl. G06F 11/27; G06F 11/263; G06F 21/54

(52) U.S. Cl. CPC G06F 11/27; G06F 11/2635; G06F 21/54

(57) ABSTRACT

Methods, systems, and devices for firmware management for memory systems are described. A memory system may allocate a first portion of one or more memory devices for storing a first set of instructions, which may be associated with performing operations of the memory system. The memory system may allocate a second portion of the one or more memory devices for storing a second set of instructions, which may be associated with performing operational evaluations of the memory system. The memory system may perform the operations of the memory system using the first set of instructions and without accessing the second portion. The memory system may perform the operational evaluations of the memory system using the second set of instructions based on an evaluation state being initiated at the memory system.

### CROSS REFERENCE

The present application for patent claims priority to U.S. Patent Application No. 63/676,224 by Redaelli, entitled “FIRMWARE MANAGEMENT FOR MEMORY SYSTEMS,” filed Jul. 26, 2024, which is assigned to the assignee hereof, and which is expressly incorporated by reference in its entirety herein.

### TECHNICAL FIELD

The following relates to one or more systems for memory, including firmware management for memory systems.

### BACKGROUND

Memory devices are widely used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored. To access the stored information, the memory device may read (e.g., sense, detect, retrieve, determine) states from the memory cells. To store information, the memory device may write (e.g., program, set, assign) states to the memory cells.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), self-selecting memory, chalcogenide memory technologies, not-or (NOR) and not-and (NAND) memory devices, and others. Memory cells may be described in terms of volatile configurations or non-volatile configurations. Memory cells configured in a non-volatile configuration may maintain stored logic states for extended periods of time even in the absence of an external power source. Memory cells configured in a volatile configuration may lose stored states when disconnected from an external power source.

### BRIEF DESCRIPTION OF THE DRAWINGS

FIG. 1 shows an example of a system that supports firmware management for memory systems in accordance with examples as disclosed herein.

FIG. 2 shows an example of a process flow that supports firmware management for memory systems in accordance with examples as disclosed herein.

FIG. 3 shows a block diagram of a memory system that supports firmware management for memory systems in accordance with examples as disclosed herein.

FIG. 4 shows a flowchart illustrating a method or methods that support firmware management for memory systems in accordance with examples as disclosed herein.

### DETAILED DESCRIPTION

Memory systems, such as managed not-AND (mNAND) systems (e.g., an embedded Multi-Media Controller (eMMC) device, a Universal Flash Storage (UFS) device, a managed non-volatile memory (mNVM) device) and solid-state drives (SSDs) may incorporate not-AND (NAND) technology as part of their architecture and may be integrated as part of an embedded system, such as an automotive system. Such memory systems may be configured to store a set of instructions (e.g., firmware, logic, software, code, or a combination thereof) used for operating the memory system. Some memory systems may utilize a single set of instructions (e.g., unified firmware structure, stored in a same location) for supporting multiple functionalities, including core functionalities (e.g., fundamental functions, baseline functions, operations of the memory system, logical-to-physical (L2P) mapping operations, memory access operations, and memory management operations) as well as diagnostic functionalities (e.g., operational evaluations, self-test operations, device field test operations, diagnostic operations). However, a single set of instructions may be relatively inefficient, for example, when updates or modifications are performed for relatively smaller portions of the instructions (e.g., such as self-test instructions). For instance, a modification to the instructions (e.g., regardless of its scale) may trigger a comprehensive revalidation process for the entire set of instructions (e.g., of the entire embedded firmware). Such modifications may thus be inefficient and resource-intensive (e.g., even for relatively minor updates to the firmware), resulting in disruptive down-time and expense.

In accordance with various techniques described herein, a memory system may be configured to separate (e.g., partition, separately store) instructions into multiple distinct instruction sets (e.g., multiple firmware components). For example, a memory system may allocate multiple portions (e.g., respective physical portions, partitions, address ranges, during a boot-up procedure, during run-time operation) of its memory device(s), and each allocated portion may store a respective set of instructions. In some examples, a memory system may be configured to separate a first set of instructions (e.g., core firmware) for performing operations of the memory system from a second set of instructions (e.g., diagnostic firmware) for performing operational evaluations of the memory system. The first set of instructions may be associated with the core functionalities of the memory system, and may be intended to remain stable and reliable (e.g., relatively unchanged). The second set of instructions may be associated with internal evaluation (e.g., self-test) operations of the memory system, such as evaluations of memory system hardware, evaluations of core instructions (e.g., the first set), or evaluations of other aspects of the memory system. In some implementations, the second set of instructions may be relatively more likely to be changed (e.g., updated) to accommodate evolving evaluations scenarios (e.g., product-specific test configurations across different products, change requests, test updates).

A memory system configured in accordance with the described techniques may operate in accordance with a respective set of instructions which, in some examples, may not access another set of instructions. For example, when performing core operations, a memory system may not access a second portion storing a second set of instructions. In some examples, an evaluation state may be activated at the memory system, which may trigger use of the second set of instructions to perform one or more operational evaluations. Due to the separation of the instruction sets, updates may be applied to the second set of instructions without impacting the first set, thereby reducing resources consumed for updating and revalidation of the memory system (e.g., for product change requests of automotive systems). For example, first and second sets of instructions may be validated (e.g., individually, collectively), and updates to the second set of instructions may be separately validated in accordance with a streamlined validation process that does not affect the validation of the first set of instructions (e.g., an initial validation of the first set of instructions may be maintained, regardless of any update to the second set of instructions). Additionally, the separate allocations may enable increased flexibility of the memory system, enhanced security, and improved user experience based on reduced product down-times, among other benefits.

In addition to applicability in memory systems as described herein, techniques for firmware management for memory systems may be generally implemented to improve the sustainability of various electronic devices and systems. As the use of electronic devices has become even more widespread, the amount of energy used and harmful emissions associated with production of electronic devices and device operation has increased. Further, the amount of waste (e.g., electronic waste) associated with disposal of electronic devices may also pose environmental concerns. Implementing the techniques described herein may improve the impact related to electronic devices by reducing validation and implementation overhead associated with firmware updates, improving updates and flexibility for existing designs and devices, and eliminating revalidation processes, which may result in lowered resource utilization, reduced electronic waste, and extended life of electronic devices, among other benefits.

Features of the disclosure are illustrated and described in the context of systems, devices, and circuits. Features of the disclosure are further illustrated and described in the context of process flow and flowcharts.

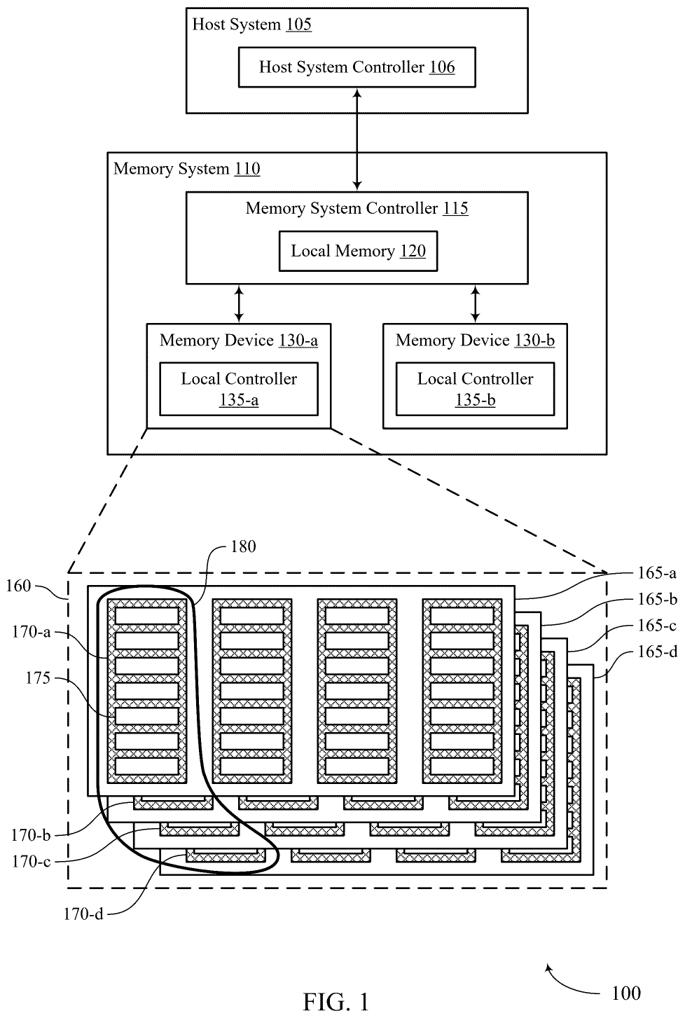

FIG. 1 shows an example of a system 100 that supports firmware management for memory systems in accordance with examples as disclosed herein. The system 100 includes a host system 105 coupled with a memory system 110. The system 100 may be included in a computing device such as a desktop computer, a laptop computer, a network server, a mobile device, a vehicle, an Internet of Things (IOT) enabled device, an embedded computer (e.g., one included in a vehicle, industrial equipment, or a networked commercial device), or any other computing device that includes memory and a processing device.

A memory system 110 may be or include any device or collection of devices, where the device or collection of devices includes at least one memory array. For example, a memory system 110 may be or include a Universal Flash Storage (UFS) device, an embedded Multi-Media Controller (eMMC) device, a flash device, a universal serial bus (USB) flash device, a secure digital (SD) card, an SSD, a hard disk drive (HDD), a dual in-line memory module (DIMM), a small outline DIMM (SO-DIMM), or a non-volatile DIMM (NVDIMM), among other devices.

The system 100 may include a host system 105, which may be coupled with the memory system 110. In some examples, this coupling may include an interface with a host system controller 106, which may be an example of a controller or control component configured to cause the host system 105 to perform various operations in accordance with examples as described herein. The host system 105 may include one or more devices and, in some cases, may include a processor chipset and a software stack executed by the processor chipset. For example, the host system 105 may include an application configured for communicating with the memory system 110 or a device therein. The processor chipset may include one or more cores, one or more caches (e.g., memory local to or included in the host system 105), a memory controller (e.g., NVDIMM controller), and a storage protocol controller (e.g., peripheral component interconnect express (PCIe) controller, serial advanced technology attachment (SATA) controller). The host system 105 may use the memory system 110, for example, to write data to the memory system 110 and read data from the memory system 110. Although one memory system 110 is shown in FIG. 1, the host system 105 may be coupled with any quantity of memory systems 110.

The host system 105 may be coupled with the memory system 110 via at least one physical host interface. The host system 105 and the memory system 110 may, in some cases, be configured to communicate via a physical host interface using an associated protocol (e.g., to exchange or otherwise communicate control, address, data, and other signals between the memory system 110 and the host system 105). Examples of a physical host interface may include, but are not limited to, a SATA interface, a UFS interface, an eMMC interface, a PCIe interface, a USB interface, a Fiber Channel interface, a Small Computer System Interface (SCSI), a Serial Attached SCSI (SAS), a Double Data Rate (DDR) interface, a DIMM interface (e.g., DIMM socket interface that supports DDR), an Open NAND Flash Interface (ONFI), and a Low Power Double Data Rate (LPDDR) interface. In some examples, one or more such interfaces may be included in or otherwise supported between a host system controller 106 of the host system 105 and a memory system controller 115 of the memory system 110. In some examples, the host system 105 may be coupled with the memory system 110 (e.g., the host system controller 106 may be coupled with the memory system controller 115) via a respective physical host interface for each memory device 130 included in the memory system 110, or via a respective physical host interface for each type of memory device 130 included in the memory system 110.

The memory system 110 may include a memory system controller 115 and one or more memory devices 130. A memory device 130 may include one or more memory arrays of any type of memory cells (e.g., non-volatile memory cells, volatile memory cells, or any combination thereof). Although two memory devices 130-a and 130-b are shown in the example of FIG. 1, the memory system 110 may include any quantity of memory devices 130. Further, if the memory system 110 includes more than one memory device 130, different memory devices 130 within the memory system 110 may include the same or different types of memory cells.

The memory system controller 115 may be coupled with and communicate with the host system 105 (e.g., via the physical host interface) and may be an example of a controller or control component configured to cause the memory system 110 to perform various operations in accordance with examples as described herein. The memory system controller 115 may also be coupled with and communicate with memory devices 130 to perform operations such as reading data, writing data, erasing data, or refreshing data at a memory device 130-among other such operations-which may generically be referred to as access operations. In some cases, the memory system controller 115 may receive commands from the host system 105 and communicate with one or more memory devices 130 to execute such commands (e.g., at memory arrays within the one or more memory devices 130). For example, the memory system controller 115 may receive commands or operations from the host system 105 and may convert the commands or operations into instructions or appropriate commands to achieve the desired access of the memory devices 130. In some cases, the memory system controller 115 may exchange data with the host system 105 and with one or more memory devices 130 (e.g., in response to or otherwise in association with commands from the host system 105). For example, the memory system controller 115 may convert responses (e.g., data packets or other signals) associated with the memory devices 130 into corresponding signals for the host system 105.

The memory system controller 115 may be configured for other operations associated with the memory devices 130. For example, the memory system controller 115 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., logical block addresses (LBAs)) associated with commands from the host system 105 and physical addresses (e.g., physical block addresses) associated with memory cells within the memory devices 130.

The memory system controller 115 may include hardware such as one or more integrated circuits or discrete components, a buffer memory, or a combination thereof. The hardware may include circuitry with dedicated (e.g., hard-coded) logic to perform the operations ascribed herein to the memory system controller 115. The memory system controller 115 may be or include a microcontroller, special purpose logic circuitry (e.g., a field programmable gate array (FPGA), an application specific integrated circuit (ASIC), a digital signal processor (DSP)), or any other suitable processor or processing circuitry.

The memory system controller 115 may also include a local memory 120. In some cases, the local memory 120 may include read-only memory (ROM) or other memory that may store operating code (e.g., executable instructions) executable by the memory system controller 115 to perform functions ascribed herein to the memory system controller 115. In some cases, the local memory 120 may additionally, or alternatively, include static random access memory (SRAM) or other memory that may be used by the memory system controller 115 for internal storage or calculations, for example, related to the functions ascribed herein to the memory system controller 115. Additionally, or alternatively, the local memory 120 may serve as a cache for the memory system controller 115. For example, data may be stored in the local memory 120 if read from or written to a memory device 130, and the data may be available within the local memory 120 for subsequent retrieval for or manipulation (e.g., updating) by the host system 105 (e.g., with reduced latency relative to a memory device 130) in accordance with a cache policy.

Although the example of the memory system 110 in FIG. 1 has been illustrated as including the memory system controller 115, in some cases, a memory system 110 may not include a memory system controller 115. For example, the memory system 110 may additionally, or alternatively, rely on an external controller (e.g., implemented by the host system 105) or one or more local controllers 135, which may be internal to memory devices 130, respectively, to perform the functions ascribed herein to the memory system controller 115. In general, one or more functions ascribed herein to the memory system controller 115 may, in some cases, be performed instead by the host system 105, a local controller 135, or any combination thereof. In some cases, a memory device 130 that is managed at least in part by a memory system controller 115 may be referred to as a managed memory device. An example of a managed memory device is mNAND device.

A memory device 130 may include one or more arrays of non-volatile memory cells. For example, a memory device 130 may include NAND (e.g., NAND flash) memory, ROM, phase change memory (PCM), self-selecting memory, other chalcogenide-based memories, ferroelectric random access memory (FeRAM), magneto RAM (MRAM), NOR (e.g., NOR flash) memory, Spin Transfer Torque (STT)-MRAM, conductive bridging RAM (CBRAM), resistive random access memory (RRAM), oxide based RRAM (OxRAM), electrically erasable programmable ROM (EEPROM), or any combination thereof. Additionally, or alternatively, a memory device 130 may include one or more arrays of volatile memory cells. For example, a memory device 130 may include RAM memory cells, such as dynamic RAM (DRAM) memory cells and synchronous DRAM (SDRAM) memory cells.

In some examples, a memory device 130 may include (e.g., on the same die, within the same package) a local controller 135, which may execute operations on one or more memory cells of the respective memory device 130. A local controller 135 may operate in conjunction with a memory system controller 115 or may perform one or more functions ascribed herein to the memory system controller 115. For example, as illustrated in FIG. 1, a memory device 130-a may include a local controller 135-a and a memory device 130-b may include a local controller 135-b. A local controller 135 may be or include a microcontroller, special purpose logic circuitry (e.g., a field programmable gate array (FPGA), an application specific integrated circuit (ASIC), a digital signal processor (DSP)), or any other suitable processor or processing circuitry.

In some cases, a memory device 130 may be or include a NAND device (e.g., NAND flash device). A memory device 130 may be or include a die 160 (e.g., a memory die). For example, in some cases, a memory device 130 may be a package that includes one or more dies 160. A die 160 may, in some examples, be a piece of electronics-grade semiconductor cut from a wafer (e.g., a silicon die cut from a silicon wafer). Each die 160 may include one or more planes 165, and each plane 165 may include a respective set of blocks 170, where each block 170 may include a respective set of pages 175, and each page 175 may include a set of memory cells.

In some cases, a NAND memory device 130 may include memory cells configured to each store one bit of information, which may be referred to as single level cells (SLCs). Additionally, or alternatively, a NAND memory device 130 may include memory cells configured to each store multiple bits of information, which may be referred to as multi-level cells (MLCs) if configured to each store two bits of information, as tri-level cells (TLCs) if configured to each store three bits of information, as quad-level cells (QLCs) if configured to each store four bits of information, or more generically as multiple-level memory cells. Multiple-level memory cells may provide greater density of storage relative to SLC memory cells but may, in some cases, involve narrower read or write margins or greater complexities for supporting circuitry.

In some cases, planes 165 may refer to groups of blocks 170 and, in some cases, concurrent operations may be performed on different planes 165. For example, concurrent operations may be performed on memory cells within different blocks 170 so long as the different blocks 170 are in different planes 165. In some cases, an individual block 170 may be referred to as a physical block, and a virtual block 180 may refer to a group of blocks 170 within which concurrent operations may occur. For example, concurrent operations may be performed on blocks 170-a, 170-b, 170-c, and 170-d that are within planes 165-a, 165-b, 165-c, and 165-d, respectively, and blocks 170-a, 170-b, 170-c, and 170-d may be collectively referred to as a virtual block 180. In some cases, a virtual block may include blocks 170 from different memory devices 130 (e.g., including blocks in one or more planes of memory device 130-a and memory device 130-b). In some cases, the blocks 170 within a virtual block may have the same block address within their respective planes 165 (e.g., block 170-a may be “block 0” of plane 165-a, block 170-b may be “block 0” of plane 165-b, and so on). In some cases, performing concurrent operations in different planes 165 may be subject to one or more restrictions, such as concurrent operations being performed on memory cells within different pages 175 that have the same page address within their respective planes 165 (e.g., related to command decoding, page address decoding circuitry, or other circuitry being shared across planes 165).

In some cases, a block 170 may include memory cells organized into rows (pages 175) and columns (e.g., strings, not shown). For example, memory cells in the same page 175 may share (e.g., be coupled with) a common word line, and memory cells in the same string may share (e.g., be coupled with) a common digit line (which may alternatively be referred to as a bit line).

For some NAND architectures, memory cells may be read and programmed (e.g., written) at a first level of granularity (e.g., at a page level of granularity, or portion thereof) but may be erased at a second level of granularity (e.g., at a block level of granularity). That is, a page 175 may be the smallest unit of memory (e.g., set of memory cells) that may be independently programmed or read (e.g., programed or read concurrently as part of a single program or read operation), and a block 170 may be the smallest unit of memory (e.g., set of memory cells) that may be independently erased (e.g., erased concurrently as part of a single erase operation). Further, in some cases, NAND memory cells may be erased before they can be re-written with new data. Thus, for example, a used page 175 may, in some cases, not be updated until the entire block 170 that includes the page 175 has been erased.

In some cases, to update some data within a block 170 while retaining other data within the block 170, the memory device 130 may copy the data to be retained to a new block 170 and write the updated data to one or more remaining pages of the new block 170. The memory device 130 (e.g., the local controller 135) or the memory system controller 115 may mark or otherwise designate the data that remains in the old block 170 as invalid or obsolete and may update a L2P mapping table to associate the logical address (e.g., LBA) for the data with the new, valid block 170 rather than the old, invalid block 170. In some cases, such copying and remapping may be performed instead of erasing and rewriting the entire old block 170 due to latency or wearout considerations, for example. In some cases, one or more copies of an L2P mapping table may be stored within the memory cells of the memory device 130 (e.g., within one or more blocks 170 or planes 165) for use (e.g., reference and updating) by the local controller 135 or memory system controller 115.

In some cases, L2P mapping tables may be maintained and data may be marked as valid or invalid at the page level of granularity, and a page 175 may contain valid data, invalid data, or no data. Invalid data may be data that is outdated, which may be due to a more recent or updated version of the data being stored in a different page 175 of the memory device 130. Invalid data may have been previously programmed to the invalid page 175 but may no longer be associated with a valid logical address, such as a logical address referenced by the host system 105. Valid data may be the most recent version of such data being stored on the memory device 130. A page 175 that includes no data may be a page 175 that has never been written to or that has been erased.

In some cases, a memory system controller 115 or a local controller 135 may perform operations (e.g., as part of one or more media management algorithms) for a memory device 130, such as wear leveling, background refresh, garbage collection, scrub, block scans, health monitoring, or others, or any combination thereof. For example, within a memory device 130, a block 170 may have some pages 175 containing valid data and some pages 175 containing invalid data. To avoid waiting for all of the pages 175 in the block 170 to have invalid data in order to erase and reuse the block 170, an algorithm referred to as “garbage collection” may be invoked to allow the block 170 to be erased and released as a free block for subsequent write operations. Garbage collection may refer to a set of media management operations that include, for example, selecting a block 170 that contains valid and invalid data, selecting pages 175 in the block that contain valid data, copying the valid data from the selected pages 175 to new locations (e.g., free pages 175 in another block 170), marking the data in the previously selected pages 175 as invalid, and erasing the selected block 170. As a result, the quantity of blocks 170 that have been erased may be increased such that more blocks 170 are available to store subsequent data (e.g., data subsequently received from the host system 105).

In some cases, a memory system 110 may utilize a memory system controller 115 to provide a managed memory system that may include, for example, one or more memory arrays and related circuitry combined with a local (e.g., on-die or in-package) controller (e.g., local controller 135). An example of a managed memory system is an mNAND system.

Some memory systems 110 (e.g., and/or host systems 105) may be integrated components of embedded systems (e.g., at least the memory system 110 may be embedded as part of an automotive system or other embedded computing system). Such a memory system 110 may store instructions (e.g., firmware, logic, software) for controlling the memory system 110 in the local memory 120 or the memory devices 130. In various examples, such instructions may be associated with core functionalities (e.g., L2P operations, access operations of the memory devices 130, memory management operations) as well as diagnostic functionalities (e.g., evaluation operations, self-test(s)), among other examples. However, having a unified set of instructions (e.g., a unified firmware structure) may be inefficient and resource-intensive for making updates (e.g., to support even minor updates to the firmware), which may involve disruptive down-time and expense.

In accordance with various techniques described herein, a memory system 110 (e.g., a memory system controller 115) may be configured to support partitioning instructions into multiple distinct instruction sets (e.g., multiple firmware components). For example, a memory system 110 may allocate multiple portions (e.g., respective physical portions, partitions, address ranges) of one or more memory device 130, local memory 120, or a combination thereof, and each allocated portion may store a respective set of instructions. For example, a memory system 110 may be configured to separate firmware into at least a first set of instructions and a second set of instructions. The first set of instructions may include core firmware for performing core operations of the memory system (e.g., mNVM functionalities and features excluding a diagnostic capability), and the second set of instructions may include diagnostic firmware for performing operational evaluations of the memory system 110 (e.g., features of the diagnostic capability), and the memory system 110 may be configured to store the first and second sets of instructions in separate firmware partitions. In some implementations, the first set of instructions may remain relatively stable and reliable (e.g., relatively unchanged), and the second set of instructions may be relatively more likely to be changed (e.g., updated).

A memory system 110 configured in accordance with the described techniques may operate in accordance with a respective set of instructions which, in some examples, may not access another set of instructions. For example, when performing core operations, a memory system 110 may not access a second portion storing a second set of instructions (e.g., related to a self-test capability). In some examples, an evaluation state may be activated at the memory system 110, which may trigger use of the second set of instructions to perform one or more operational evaluations. Due to the separation of the instruction sets, updates may be applied to the second set of instructions without impacting the first set, thereby reducing resources consumed for updating and revalidation of the memory system 110 (e.g., for product change requests of automotive systems). For example, first and second sets of instructions may be validated (e.g., individually, collectively), and updates to the second set of instructions may be separately validated in accordance with a streamlined validation process that does not affect the validation of the first set of instructions (e.g., an initial validation of the first set of instructions may be maintained, regardless of any update to the second set of instructions). Additionally, the separate allocations may enable increased flexibility of the memory system 110, enhanced security, and improved user experience based on reduced product down-times, among other benefits.

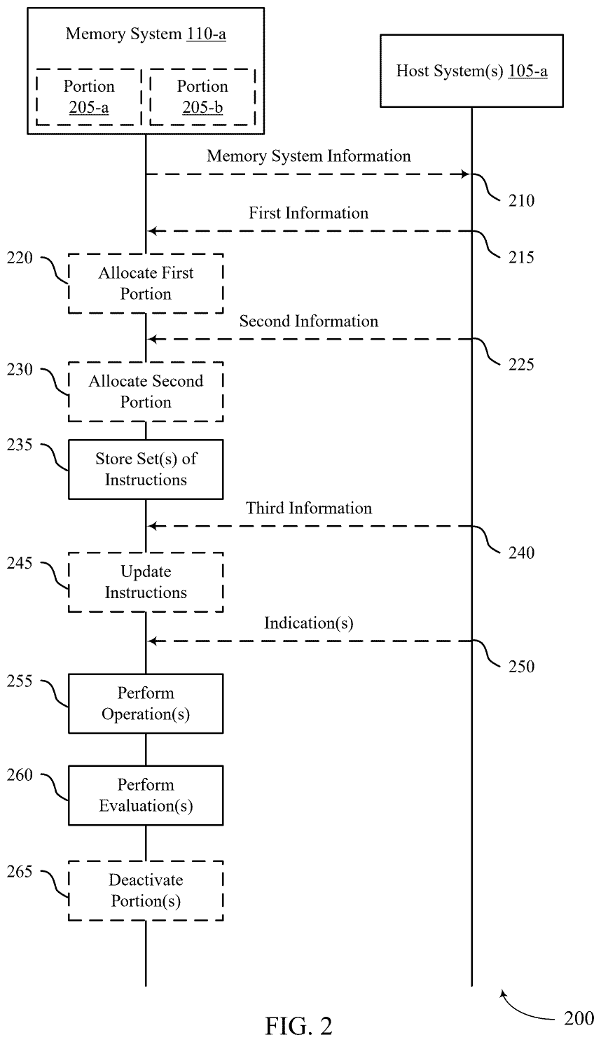

FIG. 2 shows an example of a process flow 200 that supports firmware management for memory systems in accordance with examples as disclosed herein. The process flow 200 may include a memory system 110-a and one or more host systems 105-a. The memory system 110-a may include one or more portions 205 (e.g., storage portions, partitions, allocations, respective ranges of one or more storage locations), which may be associated with storing respective sets of instructions (e.g., firmware portions) for the memory system 110-a. In various examples, a portion 205-a and a portion 205-b may be associated with the same memory device(s) 130, with different memory device(s) 130, or with some other storage location of the system (e.g., other non-volatile memory, within a memory system controller 115 of the memory system 110-a, within local memory 120 of the memory system 110-a). Although the memory system 110-a includes a portion 205-a and a portion 205-b, memory systems may support other configurations of portions 205, including more or fewer portions 205 than shown.

Some memory systems 110-a (e.g., mNAND devices, SSD devices, mNVM devices, HDDs, automotive systems, or other embedded systems including a memory system 110) may be equipped with instructions to perform fundamental operations as well as built-in monitoring and evaluation operations. Built-in evaluation operations may be referred to as “self-tests” (e.g., device field self-test, self-monitoring, analysis, and reporting technology), which may be associated with evaluating components of the memory system 110-a itself. Throughout the examples described herein, “instructions” may also be referred to as “firmware,” “software,” “logic,” or other similar term. In some examples, such instructions may refer to a set of coded commands or directives that may be interpreted and executed by one or more devices described herein, including the memory system 110-a.

In some cases, instructions associated with performing self-test operations may be integrated as part of a single set of instructions (e.g., mNVM firmware). That is, a single set of instructions may include a complete set of instructions to control operations of the memory system 110-a (e.g., core operations), as well as self-test operations (e.g., diagnostic operations) and other operations. In some implementations, the single set of instructions may be stored in the same storage location (e.g., a same memory device 130, or partition thereof). Accordingly, modifications to any portion of the instructions, including those associated with a self-test capability, may result in substantive updates (e.g., upgrade) to the instruction set as a whole (e.g., after the memory system 110 is deployed in the field, via over-the-air (OTA) updates, at vehicle service centers, or during repair). Such firmware structures may reduce flexibility in the system, for example, by limiting a customization of self-test operations (e.g., on a per-product basis). For example, a modification to any portion of the set of instructions may trigger a comprehensive revalidation of at least some, if not all of the other portions of the instructions (e.g., resulting in a product change request (PCR) in the automotive sector).

In accordance with techniques described herein, the memory system 110-a may be configured to separate (e.g., partition) firmware instruction sets (e.g., including multiple types of firmware, production firmware) into multiple distinct components (e.g., into separate sets of instructions). For example, the memory system 110-a may separate core firmware (e.g., a first set of instructions) from diagnostic firmware (e.g., a second set of instructions), which may involve allocating separate portions 205 of its storage components. The core firmware may be associated with instructions for operations of the memory system 110-a, which may include all fundamental operations, functionalities, and features of the memory system 110-a excluding self-test and self-monitoring capabilities. For example, the operations of the memory system 110-a may include the operations performed or executed by a memory system controller 115 or a local controller 135 (e.g., as described with reference to FIG. 1) such as access operations, data management operations, media management operations, signaling operations, and communication operations, among other examples.

The diagnostic firmware may be associated with instructions for operational evaluations (e.g., may be dedicated to supporting the self-test(s) feature). For example, the operational evaluations of the memory system 110-a may include operations to determine whether one or more components (e.g., hardware, logic, firmware) of the memory system 110-a, one or more operations of the memory system 110-a, or other aspects of the memory system 110-a satisfy a performance expectation. For instance, operational evaluations may involve performing one or more self-tests associated with the memory system controller 115, the memory device(s) 130 (e.g., a local controller 135, a die 160 or its components), the core firmware, or other components. The operational evaluations may evaluate for (e.g., determine, identify) one or more faults or failures of the hardware, firmware, or other aspects of the memory system 110-a.

In some examples, core firmware and diagnostic firmware may be stored in separate portions 205 (e.g., firmware partitions) of the memory system 110-a (e.g., within a memory system controller 115, memory devices 130, local memory 120, or other storage location of the memory system 110-a, or combination thereof). The memory system 110-a may include various portions 205 (e.g., any quantity of portions 205) to support storage of firmware or other instructions. That is, a portion 205 (e.g., a firmware partition) may be a designated storage location in the memory system 110-a (e.g., in or accessible to a controller thereof) for a set of instructions (e.g., a firmware image). The memory system 110-a may thus accommodate multiple independent sets of instructions. Each portion 205 (e.g., firmware partition) may be associated with a unique identifier, which may be used (e.g., by the memory system 110-a and/or host system(s) 105-a) to differentiate respective portions 205.

In some examples (e.g., during an initialization procedure), the memory system 110-a may transmit information (e.g., metadata) about its own capabilities, configurations, capacity, geometry, and other aspects to a host system 105-a. For example, such information may include an indication of a quantity of portions 205 that support store respective sets of instructions, one or more identifiers associated with each portion 205, an indication of whether the memory system 110-a supports separate portions, or other information associated with the memory system 110-a. Accordingly, a host system 105-a may configure the memory system 110-a to store respective sets of firmware instructions based on the information transmitted by the memory system 110-a. In some examples, a host system 105-a that configures the memory system 110-a to store instruction sets may be the same as or different from a host system 105-a that regularly performs operations with the memory system 110-a. For example, the memory system 110-a may be configured by a first host system 105-a prior to deployment (e.g., loaded with an initial firmware set, before being installed in a vehicle) and may be later coupled with a second host system 105-a (e.g., which may utilize or update the configuration of the memory system 110-a after installation) for regular operations.

To accommodate multiple instruction sets, the memory system 110-a may support techniques to download, activate, and deactivate each set of instructions (e.g., independently of each other). In some examples, when downloading (e.g., receiving, obtaining) a set of new firmware instructions to the memory system 110-a, a host system 105-a (e.g., host software) may specify which portion 205 (e.g., which image) is to be replaced (e.g., partially replaced, updated, overwritten, modified) by indicating an identifier associated with a portion 205 (e.g., a firmware partition number). For example, a download process may include specifying (e.g., by a host system 105-a) a target portion 205 (e.g., a target firmware partition) for the new set of instructions (e.g., new image). That is, a host system 105-a may control updating of the portions 205 by indicating a partition identifier (e.g., or some other identifier), thus ensuring that the core firmware and diagnostic firmware are managed separately.

A memory system 110-a may activate different sets of instructions (e.g., stored in different portions 205) based on various operating conditions (e.g., a vehicle state) and/or in response to signaling from a host system 105-a. In an automotive application, for example, the memory system 110-a may activate diagnostic firmware based on a triggering event, such as a key-off state of a vehicle, a charging state of the vehicle, a diagnostic state of the vehicle, or a combination thereof. Additionally, or alternatively, the evaluation state may be initiated by one or more other triggering events including (but not limited to) a mobile device low-power mode, a computing device sleep mode, a system reboot, a software update, a hardware diagnostic test, or any other condition indicative of a non-operational state or maintenance state in various electronic devices and systems. In some examples, to activate a particular set of instructions (e.g., a portion 205), a host system 105-a may activate the memory system 110-a (e.g., perform a warm start of the mNVM) and specify (e.g., select, transmit an indication of) which firmware partition to use for operating the memory system 110-a. Such flexibility may allow for improved transitions between different firmware versions, facilitating testing and updates.

In some examples, a portion 205 may be deactivated (e.g., for security purposes). For instance, a portion 205 may be temporarily deactivated or permanently deactivated to prevent unauthorized access or medications. The deactivation may be based on operating conditions (e.g., a vehicle state), signaling with a host system 105-a (e.g., via a command), or a combination thereof. The separation of portions 205 may enable partial firmware deactivation of the memory system 110-a. That is, a first set of instructions stored in a portion 205-a may be deactivated while a second set of instructions in a portion 205-b may be activated. Such deactivation capabilities may improve the integrity of the diagnostic firmware for the memory system 110-a.

By separating and allocating multiple portions 205 to store different sets of firmware instructions (e.g., separating the core functionalities from the diagnostic capabilities), the memory system 110-a may support independent updates to the respective firmware sets (e.g., independent diagnostic firmware updates). That is, such separation techniques may support improvements, bug fixes, or customizations to diagnostic firmware (e.g., the device field self-test) without performing a full system firmware update (e.g., without affecting core functionalities). Consequently, in some application examples (e.g., automotive applications), a frequency of comprehensive change requests and associated revalidation processes may be reduced, saving time and resources and improving user experience. Additionally, the separate portions 205 may support additional customization (e.g., updates, modifications) of diagnostic firmware (e.g., self-test sets) without disrupting the primary functions of the memory system 110-a.

In some examples, a decoupling of core firmware and diagnostic firmware may enhance the reliability of the overall system (e.g., a system 100). For instance, because updates to the diagnostic capabilities may not affect the core functionalities, a validation process may become more streamlined and potential issues may be isolated and resolved more quickly. Further, the described techniques may reduce device downtime as updates to the diagnostic firmware may be performed in the background, allowing the memory system 110-a to remain operational during updates, and firmware upgrades may be relatively smaller. Additionally, separating the portions 205 may support enhanced security. For example, unauthorized access or modifications to the diagnostic firmware may be prevented, ensuring controlled access to the system firmware. This feature may maintain integrity of the diagnostic processes and may protect the memory system 110-a from potential security breaches.

The process flow 200 may implement or be implemented to realize aspects of the system 100. The process flow may illustrate an example of the techniques described herein, however, alternative examples of the following may be implemented. For example, some steps may be performed in a different order than described or are not performed at all. In some implementations, the operations and signaling may include additional features not mentioned below, or further operations and signaling may be added. Further, although the memory system 110-a and the host system(s) 105-a are shown performing the operations of the process flow 200, some aspects may also be performed by one or more devices or components not shown (e.g., a memory system controller 115, a local controller 135, one or more host system controllers 106, or other processing circuitry or combination thereof).

At 210, the memory system 110-a may transmit (e.g., send, output, convey) information (e.g., capability information, metadata) associated with the memory system 110-a, which may be received by a host system 105-a (e.g., to identify the memory system 110-a). The information may include a quantity of portions 205 of one or more memory devices (e.g., memory devices 130, local memory 120) available for storing instructions, a respective identifier for each portion 205 of the quantity of portions (e.g., of the memory system 110-a), a respective storage capacity for each portion 205 of the quantity of portions, a storage capacity of the one or more memory devices, or a combination thereof.

At 215, in some examples, the memory system 110-a may receive (e.g., identify, obtain) first information including a first set of instructions (e.g., a first firmware image, a first firmware partition, core firmware instructions), which may be transmitted by a host system 105-a (e.g., a host system 105-a that received the information of 210). In some examples, the first information may include a first identifier associated with a first portion 205-a (e.g., to be allocated) of the one or more memory devices for storing the first set of instructions. The first identifier may be based on the information transmitted by the memory system 110-a.

At 220, in some examples, the memory system 110-a may allocate (e.g., partition, select, designate) the first portion 205-a of the one or more memory devices for storing (e.g., writing) the first set of instructions. In some examples, the first portion 205-a may be allocated as part of a boot-up procedure (e.g., by default). In some examples, the first set of instructions may be associated with performing operations (e.g., fundamental operations) of the memory system 110-a. In some examples, the memory system 110-a may allocate the first portion 205-a based on (e.g., in response to, after) receiving the first information.

At 225, in some examples, the memory system 110-a may receive second information including a second set of instructions (e.g., a second firmware image, a second firmware partition, diagnostic firmware instructions), which may be transmitted by a host system 105-a (e.g., a host system 105-a that received the information of 210). In some examples, the second information may include a second identifier associated with a second portion 205-b (e.g., to be allocated) of the one or more memory devices for storing the second set of instructions.

At 230, in some examples, the memory system 110-a may allocate the second portion 205-b of the one or more memory devices for storing the second set of instructions. The second portion 205-b may be different from (e.g., physically different from, logically different from) the first portion 205-a. In some examples, the second portion 205-b may be allocated during run-time operations (e.g., after a boot-up procedure, based on an activation of diagnostic firmware) or as part of a boot-up procedure. In some examples, the first portion 205-a and the second portion 205-b may be allocated to distinct memory devices 130 of the memory system 110-a or to the same memory device 130. In some examples, the first portion 205-a and/or the second portion 205-b may be stored at a controller of the memory system 110-a (e.g., in local memory 120). In some examples, the second set of instructions may be associated with performing operational evaluations of the memory system 110-a. In some examples, the memory system 110-a may allocate the second portion 205-b based on (e.g., in response to, after) receiving the second information. In some other examples, the allocation operations of 220, 230, or both may be performed before receiving respective instructions (e.g., before the operations of 215, of 225, or both), such as being configured allocations of certain addresses (e.g., logical addresses, physical addresses) of the memory system 110-a (e.g., based on an initial power-up of the memory system 110-a, based on an initial coupling with a host system 105, based on transmitting memory system information at 210, before transmitting memory system at 210, which may include information of the allocation of the portion 205-a, the portion 205-b, or both).

At 235, the memory system 110-a may store (e.g., write) one or more sets of instructions to respective portions 205. For example, the memory system 110-a may store the first set of instructions to the first portion 205-a based on the first portion 205-a being allocated to instructions for performing operations of the memory system. Additionally, or alternatively, the memory system 110-a may store the second set of instructions to the second portion 205-b based on the second portion 205-b being allocated to instructions for performing operational evaluations of the memory system. In some examples, the receiving of information (e.g., from one or more host systems 105-a), the allocation of portion 205, the storing of instructions to the respective portions 205, or a combination thereof may be associated with a downloading process (e.g., a firmware imaging process) at the memory system 110-a.

At 240, in some examples, the memory system 110-a may receive third information including a third set of instructions, which may be transmitted by a host system 105-a (e.g., a host system 105-a that is the same as or different from the host system 105-a associated with the instructions of 215 or 225). The third information may be associated with updating the second set of instructions (e.g., may be associated with a diagnostic firmware update). For example, the third information may include the second identifier associated with the second portion 205-b of the one or more memory devices.

At 245, in some examples, the memory system 110-a may update respective portions 205 (and the instructions stored therein) independently of each other. For example, the memory system 110-a may update the instructions stored in the second portion 205-b independently of (e.g., without affecting or accessing) the instructions stored in first portion 205-a. In some examples, the memory system 110-a may replace (e.g., overwrite, updated, modify) the second set of instructions stored at the second portion 205-b with (e.g., or based on) the third set of instructions without accessing the first portion 205-a. The memory system 110-a may perform the updates based on receiving the third information. Additionally, or alternatively, the memory system 110-a may receive other information (e.g., via fourth information, not shown, or via some other indication) for updating the first set of instructions, and may update the first set of instructions store at the first portion 205-a independently (e.g., without affecting or accessing the second portion 205-b).

At 250, in some examples, the memory system 110-a may receive, at the memory system 110-a, an indication to operate in accordance with a mode that uses the first set of instructions for performing the operations of the memory system 110-a. Such an indication may be associated with activating a non-diagnostic operating mode (e.g., a baseline operational mode, a nominal operational mode, a mode in which self-testing is not performed) at the memory system 110-a. Additionally, or alternatively, the memory system 110-a may receive an indication (e.g., from a host system 105-a coupled with the memory system 110-a, a host system 105-a associated with ongoing or evaluation operations of the memory system 105-a) to initiate (e.g., enter, activate) an evaluation state (e.g., an evaluation mode, a second mode different from the first mode). Accordingly, the indication may be associated with activating a diagnostic mode at the memory system 110-a.

At 255, the memory system 110-a may perform the operations of the memory system 110-a using (e.g., reading, executing, implementing) the first set of instructions and without accessing the second portion 205-b. The memory system 110-a may perform these operations based on receiving the indication (e.g., from a host system 105-a) to operate in accordance with the mode. The operations of the memory system 110-a may include one or more L2P mapping operations, one or more memory management operations (e.g., garbage collection, refresh, error detection and correction), one or more access operations (e.g., reading, writing) of the one or more memory devices of the memory system 110-a, or a combination thereof.

At 260, the memory system 110-a may perform the operational evaluations of the memory system 110-a using (e.g., reading, executing, implementing) the second set of instructions. The memory system 110-a may perform the operational evaluations based on an evaluation state being initiated at the memory system 110-a. In some examples, the evaluation state may be initiated by one or more triggering events, which may include but are not limited to: a vehicle key-off condition, a vehicle charging condition, a vehicle diagnostic condition, a mobile device low-power mode, a computing device sleep mode, a system reboot, a software update, a hardware diagnostic test, any other condition indicative of a non-operational state (e.g., a non-operational condition) or a maintenance state (e.g., maintenance condition) in various electronic devices and systems, or any combination thereof. The evaluation state may be initiated by a vehicle key-off condition, a vehicle charging condition, a vehicle diagnostic condition, the received indication (e.g., from the host system 105-a), or any combination thereof. The operational evaluations of the memory system 110-a may include one or more self-test operations of one or more memory devices of the memory system 110-a, of the processing circuitry (e.g., memory system controller 115, local controller 135), of other sets of instructions (e.g., the first set of instructions, other firmware), or any combination thereof.

At 265, in some examples, the memory system 110-a may deactivate at least some of the second portion 205-b in accordance with a security state initiated at the memory system 110-a. In some examples, the second set of instructions (e.g., and/or other instructions stored in the second portion 205-b) may be inaccessible and unalterable while the second portion 205-b is deactivated. For example, the memory system 110-a may initiate (e.g., enter) the security state to prevent unauthorized access and modifications to the diagnostic firmware. Additionally, or alternatively, the memory system 110-a may deactivate the first portion 205-a (e.g., or some other portion 205) in accordance with the security state to prevent unauthorized access and modifications to the core firmware or other firmware instructions stored at the memory system 110-a.

Thus, in accordance with these and other examples, the memory system 110-a may be configured to separate firmware instructions into multiple distinct sets (e.g., multiple firmware components) that are stored in different portions 205 of one or more memory devices. For example, when performing core operations that implement first instructions stored in the portion 205-a, the memory system may not access the second portion 205-b. In some examples, an evaluation state may be activated at the memory system 110-a, which may trigger use of the second set of instructions stored in the portion 205-b to perform one or more operational evaluations. Due to the separation of the instruction sets, updates may be applied to the second set of instructions in the portion 205-b without impacting the first set of instructions stored in the portion 205-a, thereby reducing resources consumed for updating and revalidation of the memory system 110-a. Additionally, the separate allocations may enable increased flexibility of the memory system, enhanced security, and improved user experience based on reduced product down-times, among other benefits.

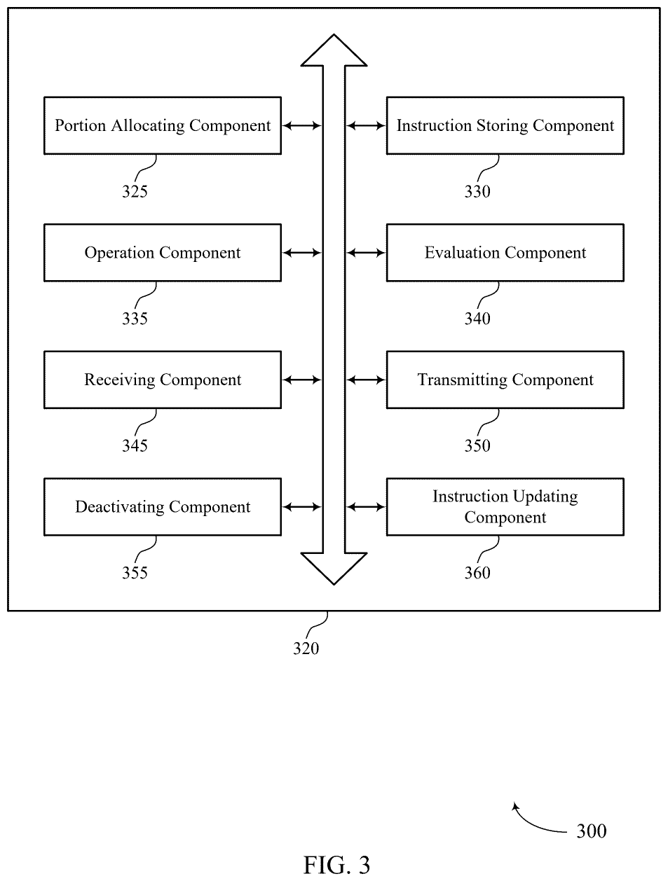

FIG. 3 shows a block diagram 300 of a memory system 320 that supports firmware management for memory systems in accordance with examples as disclosed herein. The memory system 320 may be an example of aspects of a memory system as described with reference to FIGS. 1 through 2. The memory system 320, or various components thereof, may be an example of means for performing various aspects of firmware management for memory systems as described herein. For example, the memory system 320 may include a portion allocating component 325, an instruction storing component 330, an operation component 335, an evaluation component 340, a receiving component 345, a transmitting component 350, a deactivating component 355, an instruction updating component 360, or any combination thereof. Each of these components, or components of subcomponents thereof (e.g., one or more processors, one or more memories), may communicate, directly or indirectly, with one another (e.g., via one or more buses).

The instruction storing component 330 may be configured as or otherwise support a means for storing the first set of instructions to the first portion based on the first portion being allocated to instructions for performing operations of the memory system. In some examples, the instruction storing component 330 may be configured as or otherwise support a means for storing the second set of instructions to the second portion based on the second portion being allocated to instructions for performing operational evaluations of the memory system. The operation component 335 may be configured as or otherwise support a means for performing the operations of the memory system 320 using the first set of instructions and without accessing the second portion of the one or more memory devices. The evaluation component 340 may be configured as or otherwise support a means for performing the operational evaluations of the memory system 320 using the second set of instructions based on an evaluation state being initiated at the memory system 320.

In some examples, the portion allocating component 325 may be configured as or otherwise support a means for allocating a first portion of one or more memory devices of the memory system 320 for storing a first set of instructions, the first set of instructions for performing operations of the memory system 320. In some examples, the portion allocating component 325 may be configured as or otherwise support a means for allocating a second portion of the one or more memory devices, different from the first portion, for storing a second set of instructions, the second set of instructions for performing operational evaluations of the memory system 320.

In some examples, the receiving component 345 may be configured as or otherwise support a means for receiving, at the memory system 320, first information including the first set of instructions and a first identifier associated with the first portion of the one or more memory devices, where the first portion is allocated based on receiving the first information. In some examples, the receiving component 345 may be configured as or otherwise support a means for receiving, at the memory system 320, second information including the second set of instructions and a second identifier associated with the second portion of the one or more memory devices, where the second portion is allocated based on receiving the second information.

In some examples, the receiving component 345 may be configured as or otherwise support a means for receiving, at the memory system 320, third information including a third set of instructions and the second identifier associated with the second portion of the one or more memory devices. In some examples, the instruction updating component 360 may be configured as or otherwise support a means for replacing the second set of instructions with the third set of instructions at the second portion and without accessing the first portion based on receiving the third information.

In some examples, the receiving component 345 may be configured as or otherwise support a means for receiving, at the memory system 320, an indication to operate in accordance with a mode that uses the first set of instructions for performing the operations of the memory system 320. In some examples, the operation component 335 may be configured as or otherwise support a means for performing the operations of the memory system 320 using the first set of instructions, and without accessing the second portion of the one or more memory devices, based on receiving the indication to operate in accordance with the mode.

In some examples, the evaluation state is initiated by one or more triggering events including: a vehicle key-off condition, a vehicle charging condition, a vehicle diagnostic condition, a mobile device low-power mode, a computing device sleep mode, a system reboot, a software update, a hardware diagnostic test, a non-operational condition, a maintenance condition, or any combination thereof.

In some examples, the transmitting component 350 may be configured as or otherwise support a means for transmitting information associated with the memory system 320, the information including a quantity of portions of the one or more memory devices available for storing instructions, a respective identifier for each portion of the quantity of portions, a respective storage capacity for each portion of the quantity of portions, a storage capacity of the one or more memory devices, or a combination thereof.

In some examples, the receiving component 345 may be configured as or otherwise support a means for receiving, at the memory system 320, an indication to initiate the evaluation state.

In some examples, the deactivating component 355 may be configured as or otherwise support a means for deactivating the second portion in accordance with a security state initiated at the memory system 320, where the second set of instructions is inaccessible and unalterable while the second portion is deactivated.

In some examples, the operations of the memory system 320 include one or more logical-to-physical mapping operations, one or more memory management operations, one or more access operations of the one or more memory devices, or a combination thereof.

In some examples, the operational evaluations of the memory system 320 include one or more self-test operations of the one or more memory devices, processing circuitry of the memory system 320, the first set of instructions, or any combination thereof.

In some examples, the described functionality of the memory system 320, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory system 320, or various components thereof, may be implemented at least in part by instructions (e.g., stored in memory, non-transitory computer-readable medium) executable by such at least one processor.

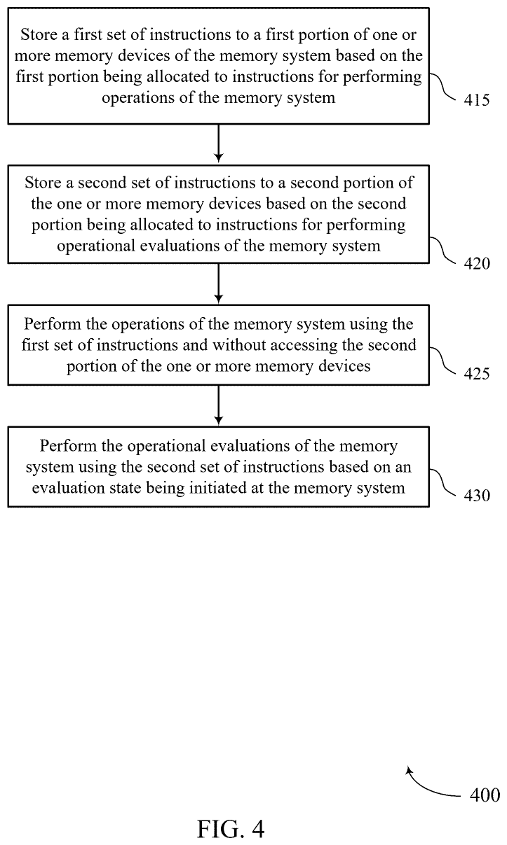

FIG. 4 shows a flowchart illustrating a method 400 that supports firmware management for memory systems in accordance with examples as disclosed herein. The operations of method 400 may be implemented by a memory system or its components as described herein. For example, the operations of method 400 may be performed by a memory system as described with reference to FIGS. 1 through 3. In some examples, a memory system (e.g., a memory system 110) may execute a set of instructions to control the functional elements of the device to perform the described functions. Additionally, or alternatively, the memory system may perform aspects of the described functions using special-purpose hardware.

At 415, the method may include storing a first set of instructions to a first portion of one or more memory devices of the memory system based on the first portion being allocated to instructions for performing operations of the memory system. In some examples, aspects of the operations of 415 may be performed by an instruction storing component 330 as described with reference to FIG. 3.

At 420, the method may include storing a second set of instructions to a second portion of the one or more memory devices based on the second portion being allocated to instructions for performing operational evaluations of the memory system. In some examples, aspects of the operations of 420 may be performed by an instruction storing component 330 as described with reference to FIG. 3.

At 425, the method may include performing the operations of the memory system using the first set of instructions and without accessing the second portion of the one or more memory devices. In some examples, aspects of the operations of 425 may be performed by an operation component 335 as described with reference to FIG. 3.

At 430, the method may include performing the operational evaluations of the memory system using the second set of instructions based on an evaluation state being initiated at the memory system. In some examples, aspects of the operations of 430 may be performed by an evaluation component 340 as described with reference to FIG. 3.

In some examples, an apparatus as described herein may perform a method or methods, such as the method 400. The apparatus may include features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for storing a first set of instructions to a first portion of one or more memory devices of the memory system based on the first portion being allocated to instructions for performing operations of the memory system; storing a second set of instructions to a second portion of the one or more memory devices based on the second portion being allocated to instructions for performing operational evaluations of the memory systema second set of instructions to a second portion of the one or more memory devices based on the second portion being allocated to instructions for performing operational evaluations of the memory system; performing the operations of the memory system using the first set of instructions and without accessing the second portion of the one or more memory devices; and performing the operational evaluations of the memory system using the second set of instructions based on an evaluation state being initiated at the memory system.

Aspect 2: The method, apparatus, or non-transitory computer-readable medium of aspect 1, further including operations, features, circuitry, logic, means, or instructions, or any combination thereof for allocating the first portion (e.g., a portion 205-a) of one or more memory devices (e.g., memory device(s) 130) for storing instructions for performing operations of the memory system, and allocating a second portion (e.g., a portion 205-b) of the one or more memory devices (e.g., different from the first portion) for storing instructions for performing operational evaluations of the memory system.

Aspect 3: The method, apparatus, or non-transitory computer-readable medium of any of aspects 1 through 2, further including operations, features, circuitry, logic, means, or instructions, or any combination thereof for receiving, at the memory system, first information including the first set of instructions and a first identifier associated with the first portion of the one or more memory devices, where the first portion is allocated based on receiving the first information and receiving, at the memory system, second information including the second set of instructions and a second identifier associated with the second portion of the one or more memory devices, where the second portion is allocated based on receiving the second information.

Aspect 4: The method, apparatus, or non-transitory computer-readable medium of aspect 3, further including operations, features, circuitry, logic, means, or instructions, or any combination thereof for receiving, at the memory system, third information including a third set of instructions and the second identifier associated with the second portion of the one or more memory devices and replacing the second set of instructions with the third set of instructions at the second portion and without accessing the first portion based on receiving the third information.

Aspect 5: The method, apparatus, or non-transitory computer-readable medium of any of aspects 1 through 4, further including operations, features, circuitry, logic, means, or instructions, or any combination thereof for receiving, at the memory system, an indication to operate in accordance with a mode that uses the first set of instructions for performing the operations of the memory system and performing the operations of the memory system using the first set of instructions, and without accessing the second portion of the one or more memory devices, based on receiving the indication to operate in accordance with the mode.

Aspect 6: The method, apparatus, or non-transitory computer-readable medium of any of aspects 1 through 5, where the evaluation state is initiated by one or more triggering events including: a vehicle key-off condition, a vehicle charging condition, a vehicle diagnostic condition, a mobile device low-power mode, a computing device sleep mode, a system reboot, a software update, a hardware diagnostic test, a non-operational condition, a maintenance condition, or any combination thereof.

Aspect 7: The method, apparatus, or non-transitory computer-readable medium of any of aspects 1 through 6, further including operations, features, circuitry, logic, means, or instructions, or any combination thereof for transmitting information associated with the memory system, the information including a quantity of portions of the one or more memory devices available for storing instructions, a respective identifier for each portion of the quantity of portions, a respective storage capacity for each portion of the quantity of portions, a storage capacity of the one or more memory devices, or a combination thereof.

Aspect 8: The method, apparatus, or non-transitory computer-readable medium of any of aspects 1 through 7, further including operations, features, circuitry, logic, means, or instructions, or any combination thereof for receiving, at the memory system, an indication to initiate the evaluation state.

Aspect 9: The method, apparatus, or non-transitory computer-readable medium of any of aspects 1 through 8, further including operations, features, circuitry, logic, means, or instructions, or any combination thereof for deactivating the second portion in accordance with a security state initiated at the memory system, where the second set of instructions is inaccessible and unalterable while the second portion is deactivated.

Aspect 10: The method, apparatus, or non-transitory computer-readable medium of any of aspects 1 through 9, where the operations of the memory system include one or more logical-to-physical mapping operations, one or more memory management operations, one or more access operations of the one or more memory devices, or a combination thereof.

Aspect 11: The method, apparatus, or non-transitory computer-readable medium of any of aspects 1 through 10, where the operational evaluations of the memory system include one or more self-test operations of the one or more memory devices, processing circuitry of the memory system, the first set of instructions, or any combination thereof.

It should be noted that the described techniques include possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit based on the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The term “coupling” (e.g., “electrically coupling”) may refer to a condition of moving from an open-circuit relationship between components in which signals are not presently capable of being communicated between the components over a conductive path to a closed-circuit relationship between components in which signals are capable of being communicated between components over the conductive path. If a component, such as a controller, couples other components together, the component initiates a change that allows signals to flow between the other components over a conductive path that previously did not permit signals to flow.

The term “isolated” refers to a relationship between components in which signals are not presently capable of flowing between the components. Components are isolated from each other if there is an open circuit between them. For example, two components separated by a switch that is positioned between the components are isolated from each other if the switch is open. If a controller isolates two components, the controller affects a change that prevents signals from flowing between the components using a conductive path that previously permitted signals to flow.

The terms “if,” “when,” “based on,” or “based at least in part on” may be used interchangeably. In some examples, if the terms “if,” “when,” “based on,” or “based at least in part on” are used to describe a conditional action, a conditional process, or connection between portions of a process, the terms may be interchangeable.

The term “in response to” may refer to one condition or action occurring at least partially, if not fully, as a result of a previous condition or action. For example, a first condition or action may be performed, and a second condition or action may at least partially occur as a result of the previous condition or action occurring (whether directly after or after one or more other intermediate conditions or actions occurring after the first condition or action).

Additionally, the terms “directly in response to” or “in direct response to” may refer to one condition or action occurring as a direct result of a previous condition or action. In some examples, a first condition or action may be performed, and a second condition or action may occur directly as a result of the previous condition or action occurring independent of whether other conditions or actions occur. In some examples, a first condition or action may be performed, and a second condition or action may occur directly as a result of the previous condition or action occurring, such that no other intermediate conditions or actions occur between the earlier condition or action and the second condition or action or a limited quantity of one or more intermediate steps or actions occur between the earlier condition or action and the second condition or action. Any condition or action described herein as being performed “based on,” “based at least in part on,” or “in response to” some other step, action, event, or condition may additionally, or alternatively (e.g., in an alternative example), be performed “in direct response to” or “directly in response to” such other condition or action unless otherwise specified.

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In some other examples, the substrate may be a silicon-on-insulator (SOI) substrate, such as silicon-on-glass (SOG) or silicon-on-sapphire (SOP), or epitaxial layers of semiconductor materials on another substrate. The conductivity of the substrate, or sub-regions of the substrate, may be controlled through doping using various chemical species including, but not limited to, phosphorus, boron, or arsenic. Doping may be performed during the initial formation or growth of the substrate, by ion-implantation, or by any other doping means.

A switching component or a transistor discussed herein may represent a field-effect transistor (FET) and comprise a three terminal device including a source, drain, and gate. The terminals may be connected to other electronic elements through conductive materials, e.g., metals. The source and drain may be conductive and may comprise a heavily-doped, e.g., degenerate, semiconductor region. The source and drain may be separated by a lightly-doped semiconductor region or channel. If the channel is n-type (i.e., majority carriers are electrons), then the FET may be referred to as an n-type FET. If the channel is p-type (i.e., majority carriers are holes), then the FET may be referred to as a p-type FET. The channel may be capped by an insulating gate oxide. The channel conductivity may be controlled by applying a voltage to the gate. For example, applying a positive voltage or negative voltage to an n-type FET or a p-type FET, respectively, may result in the channel becoming conductive. A transistor may be “on” or “activated” if a voltage greater than or equal to the transistor's threshold voltage is applied to the transistor gate. The transistor may be “off” or “deactivated” if a voltage less than the transistor's threshold voltage is applied to the transistor gate.

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a hyphen and a second label that distinguishes among the similar components. If just the first reference label is used in the specification, the description is applicable to any one of the similar components having the same first reference label irrespective of the second reference label.

The functions described herein may be implemented in hardware, software executed by a processing system (e.g., one or more processors, one or more controllers, control circuitry, processing circuitry, logic circuitry), firmware, or any combination thereof. If implemented in software executed by a processing system, the functions may be stored on or transmitted over as one or more instructions (e.g., code) on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof designed to perform the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium, or combination of multiple media, which can be accessed by a computer. By way of example, and not limitation, non-transitory computer-readable media can comprise RAM, ROM, electrically erasable programmable read-only memory (EEPROM), optical disk storage, magnetic disk storage or other magnetic storage devices, or any other non-transitory medium or combination of media that can be used to carry or store desired program code means in the form of instructions or data structures and that can be accessed by a computer, or one or more processors.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A memory system, comprising:
one or more memory devices; and
processing circuitry coupled with the one or more memory devices and configured to cause the memory system to:
store a first set of instructions to a first portion of the one or more memory devices based on the first portion being allocated to instructions for performing operations of the memory system;
store a second set of instructions to a second portion of the one or more memory devices based on the second portion being allocated to instructions for performing operational evaluations of the memory system;
perform the operations of the memory system using the first set of instructions and without accessing the second portion of the one or more memory devices; and
perform the operational evaluations of the memory system using the second set of instructions based on an evaluation state being initiated at the memory system.

2. The memory system of claim 1, wherein the processing circuitry is further configured to cause the memory system to:
receive, at the memory system, first information including the first set of instructions and a first identifier associated with the first portion of the one or more memory devices, wherein the first portion is allocated based on receiving the first information; and
receive, at the memory system, second information including the second set of instructions and a second identifier associated with the second portion of the one or more memory devices, wherein the second portion is allocated based on receiving the second information.

3. The memory system of claim 2, wherein the processing circuitry is further configured to cause the memory system to:
receive, at the memory system, third information including a third set of instructions and the second identifier associated with the second portion of the one or more memory devices; and
replace the second set of instructions with the third set of instructions at the second portion and without accessing the first portion based on receiving the third information.

4. The memory system of claim 1, wherein the processing circuitry is further configured to cause the memory system to:
receive, at the memory system, an indication to operate in accordance with a mode that uses the first set of instructions for performing the operations of the memory system; and
perform the operations of the memory system using the first set of instructions, and without accessing the second portion of the one or more memory devices, based on receiving the indication to operate in accordance with the mode.

5. The memory system of claim 1, wherein the evaluation state is initiated by one or more triggering events including: a vehicle key-off condition, a vehicle charging condition, a vehicle diagnostic condition, a mobile device low-power mode, a computing device sleep mode, a system reboot, a software update, a hardware diagnostic test, a non-operational condition, a maintenance condition, or any combination thereof.

6. The memory system of claim 1, wherein the processing circuitry is further configured to cause the memory system to:
transmit information associated with the memory system, the information comprising a quantity of portions of the one or more memory devices available for storing instructions, a respective identifier for each portion of the quantity of portions, a respective storage capacity for each portion of the quantity of portions, a storage capacity of the one or more memory devices, or a combination thereof.

7. The memory system of claim 1, wherein the processing circuitry is further configured to cause the memory system to:
receive, at the memory system, an indication to initiate the evaluation state.

8. The memory system of claim 1, wherein the processing circuitry is further configured to cause the memory system to:
deactivate the second portion in accordance with a security state initiated at the memory system, wherein the second set of instructions is inaccessible and unalterable while the second portion is deactivated.

9. The memory system of claim 1, wherein the operations of the memory system include one or more logical-to-physical mapping operations, one or more memory management operations, one or more access operations of the one or more memory devices, or a combination thereof.

10. The memory system of claim 1, wherein the operational evaluations of the memory system include one or more self-test operations of: the one or more memory devices, the processing circuitry, the first set of instructions, or any combination thereof.

11. A method by a memory system, comprising:
storing a first set of instructions to a first portion of one or more memory devices of the memory system based on the first portion being allocated to instructions for performing operations of the memory system;
storing a second set of instructions to a second portion of the one or more memory devices based on the second portion being allocated to instructions for performing operational evaluations of the memory system;
performing the operations of the memory system using the first set of instructions and without accessing the second portion of the one or more memory devices; and
performing the operational evaluations of the memory system using the second set of instructions based on an evaluation state being initiated at the memory system.

12. The method of claim 11, further comprising:
receiving, at the memory system, first information including the first set of instructions and a first identifier associated with the first portion of the one or more memory devices, wherein the first portion is allocated based on receiving the first information; and
receiving, at the memory system, second information including the second set of instructions and a second identifier associated with the second portion of the one or more memory devices, wherein the second portion is allocated based on receiving the second information.

13. The method of claim 12, further comprising:
receiving, at the memory system, third information including a third set of instructions and the second identifier associated with the second portion of the one or more memory devices; and
replacing the second set of instructions with the third set of instructions at the second portion and without accessing the first portion based on receiving the third information.

14. The method of claim 11, further comprising:
receiving, at the memory system, an indication to operate in accordance with a mode that uses the first set of instructions for performing the operations of the memory system; and
performing the operations of the memory system using the first set of instructions, and without accessing the second portion of the one or more memory devices, based on receiving the indication to operate in accordance with the mode.

15. The method of claim 11, wherein the evaluation state is initiated by one or more triggering events including: a vehicle key-off condition, a vehicle charging condition, a vehicle diagnostic condition, a mobile device low-power mode, a computing device sleep mode, a system reboot, a software update, a hardware diagnostic test, a non-operational condition, a maintenance condition, or any combination thereof.

16. The method of claim 11, further comprising:
transmitting information associated with the memory system, the information comprising a quantity of portions of the one or more memory devices available for storing instructions, a respective identifier for each portion of the quantity of portions, a respective storage capacity for each portion of the quantity of portions, a storage capacity of the one or more memory devices, or a combination thereof.

17. The method of claim 11, further comprising:
receiving, at the memory system, an indication to initiate the evaluation state.

18. The method of claim 11, further comprising:
deactivating the second portion in accordance with a security state initiated at the memory system, wherein the second set of instructions is inaccessible and unalterable while the second portion is deactivated.

19. The method of claim 11, wherein the operations of the memory system include one or more logical-to-physical mapping operations, one or more memory management operations, one or more access operations of the one or more memory devices, or a combination thereof.

20. The method of claim 11, wherein the operational evaluations of the memory system include one or more self-test operations of: the one or more memory devices, processing circuitry of the memory system, the first set of instructions, or any combination thereof.

21. A non-transitory computer-readable medium storing code comprising instructions which, when executed by processing circuitry of a memory system, cause the memory system to:
store a first set of instructions to a first portion of one or more memory devices of the memory system based on the first portion being allocated to instructions for performing operations of the memory system;
store a second set of instructions to a second portion of the one or more memory devices based on the second portion being allocated to instructions for performing operational evaluations of the memory system;
perform the operations of the memory system using the first set of instructions and without accessing the second portion of the one or more memory devices; and
perform the operational evaluations of the memory system using the second set of instructions based on an evaluation state being initiated at the memory system.

22. The non-transitory computer-readable medium of claim 21, wherein the instructions, when executed by the processing circuitry, further cause the memory system to:
receive, at the memory system, first information including the first set of instructions and a first identifier associated with the first portion of the one or more memory devices, wherein the first portion is allocated based on receiving the first information; and
receive, at the memory system, second information including the second set of instructions and a second identifier associated with the second portion of the one or more memory devices, wherein the second portion is allocated based on receiving the second information.

23. The non-transitory computer-readable medium of claim 22, wherein the instructions, when executed by the processing circuitry, further cause the memory system to:
receive, at the memory system, third information including a third set of instructions and the second identifier associated with the second portion of the one or more memory devices; and
replace the second set of instructions with the third set of instructions at the second portion and without accessing the first portion based on receiving the third information.

24. The non-transitory computer-readable medium of claim 21, wherein the instructions, when executed by the processing circuitry, further cause the memory system to:
receive, at the memory system, an indication to operate in accordance with a mode that uses the first set of instructions for performing the operations of the memory system; and
perform the operations of the memory system using the first set of instructions, and without accessing the second portion of the one or more memory devices, based on receiving the indication to operate in accordance with the mode.

25. The non-transitory computer-readable medium of claim 21, wherein the evaluation state is initiated by one or more triggering events including: a vehicle key-off condition, a vehicle charging condition, a vehicle diagnostic condition, a mobile device low-power mode, a computing device sleep mode, a system reboot, a software update, a hardware diagnostic test, a non-operational condition, a maintenance condition, or any combination thereof.
